(19) United States
(12) Patent Application Publication
(10) Pub. No.: US 2024/0019855 A1
(43) Pub. Date: Jan. 18, 2024

(54) Method and System for Providing Control Applications for Industrial Automation Devices

(71) Applicant: Siemens Aktiengesellschaft, Muenchen (DE)

(72) Inventors: Christian KNIERIM, München (DE); Christian Peter FEIST, München (DE); Harald ALBRECHT, Nürnberg (DE)

(21) Appl. No.: 18/342,858

(22) Filed: Jun. 28, 2023

(30) Foreign Application Priority Data
Jun. 30, 2022 (EP) 22182205

(51) Int. Cl. G05B 19/418

(52) U.S. Cl. CPC G05B 19/4185; G05B 2219/36542

(57) ABSTRACT

Method and system for providing control applications for industrial automation devices, wherein in order to provide control applications, which are each provided via flow control components, the flow control components are each classified, based on configuration information, or referenced memory maps, with respect to access to at least one socket of a flow control environment when their execution is started, where a classification for each of the flow control components is used to create or reference a permissions profile for socket access, an individual token, associated with a permissions profile, for the socket access is created for each flow control component and transferred to the respective flow control component, and where the tokens and/or the permissions profiles each have an application-specific resource access guideline combined with therewith which is transmitted to a control component for application, which control component opens the respective socket.

### BACKGROUND OF THE INVENTION

### 1. Field of the Invention

The present invention relates to a system and method for providing control applications for industrial automation devices.

### 2. Description of the Related Art

Industrial automation systems normally comprise a multiplicity of automation devices networked to one another via an industrial communication network and are used for controlling or regulating installations, machines or devices within the context of production or process automation. Time-critical constraints in industrial automation systems mean that predominantly real-time communication protocols, such as PROFINET, PROFIBUS, real-time Ethernet or time-sensitive networking (TSN), are used for communication between automation devices. In particular, control services or applications can be distributed over currently available servers or virtual machines of an industrial automation system in an automated manner and depending on capacity utilization.

WO 2022/042905 A1 discloses a method for providing time-critical services, each of which has at least one associated server component formed by a flow control component that can be loaded into and executed in a flow control environment. Each of the server components is provided with a functional unit for processing a communication protocol stack, which is connected to a functional unit for processing a communication protocol stack that is associated with the flow control environment. The services each comprise a directory service component for ascertaining services provided via the flow control environment. The directory service components are connected to one another via a separate communication interface. The separate communication interface has an aggregator component connected to it that is formed via a further flow control component and that provides details about the services provided via the server components outside the flow control environment.

European Application No. 21212849.0 describes a method for providing control applications, in which the control applications are each provided via flow control components that can be loaded into and executed in a flow control environment formed via a server apparatus. Control applications that require selected security permissions are each assigned an identification as a security-critical control application. For each of the control applications that have an associated identification as a security-critical control application, at least one expiration condition for the selected security permissions is established. The flow control environment monitors the occurrence of the respective expiration condition while the flow control components for each of the control applications are executed. The execution of the flow control components is terminated whenever the respective expiration condition occurs.

European Application No. 22177736.0 discloses a method for providing control applications via flow control components for control applications whose execution requires selected privileges. This is accomplished by producing a respective specification of required security-critical resources. Each of the specifications is used to ascertain an additional flow control component that is intended for providing access to the required security-critical resources. Accordingly, execution of the respective flow control component is started together with the additional flow control component. A flow control environment sets up an interface for interprocess communication between the respective flow control component and the additional flow control component. The access to the respectively required security-critical resources is provided via interprocess communication between the respective flow control component and the additional flow control component.

For control applications that are made available via container virtualization, in particular configuration information or deployment information, such as a Docker Compose file, can be used to define those resources of a host for which the respective control application is accorded access. These resources can comprise device files or persistent memory areas (volumes), for example, which are assigned to an application instance in order to be able to persist data. In addition, access to a socket of a container runtime environment, e.g., Docker socket, can also be granted, and so control applications with appropriately granted resource access can perform operations via the socket of the container runtime environment. Access to a socket of a container runtime environment is normally granted via a socket file, which can be mounted as a mount point in an instance of a control application provided via container virtualization. As soon as an instance of a control application is accorded access to a socket file of a container runtime environment, admissible operations via the socket of the container runtime environment can no longer be restricted granularly to selected operations or API calls. Only read rights or write rights to the socket file as a whole can be controlled.

### SUMMARY OF THE INVENTION

In view of the foregoing, it is therefore an object of the present invention to provide a device and method for providing control applications that request access to a socket of a flow control environment, where the device and method facilitate selective and efficient establishment of admissible and inadmissible operations via the socket.

These and other objects and advantages are achieved in accordance with the invention by a system and method in which control applications for industrial automation devices are each provided via flow control components that can be loaded into and executed in a flow control environment formed via a host. Deployment information, such as a Docker Compose file, or configuration information comprising at least one reference to a memory map (image) for the respective flow control component and application-specific stipulations for the use of resources of the host is prescribed for each of the flow control components. The configuration information is preferably used for loading or executing each respective flow control component.

In particular, the flow control components may be or comprise software containers that each run on a host operating system of a server apparatus within the flow control environment in isolation from other software containers or container groups, e.g., pods. In principle, alternative micro-virtualization concepts, such as snaps, can also be used for the flow control components. The software containers preferably each utilize a shared kernel of the host operating system of the server apparatus together with other software containers running on the respective server apparatus. By way of example, memory maps for the software containers can be retrieved from a memory and provision system to which a multiplicity of users can have read or write access.

The flow control environment may be in particular a container runtime environment or container engine that sets up, deletes or combines virtual resources. The virtual resources in this case comprise software containers, virtual communication networks and connections associated therewith. By way of example, the flow control environment may comprise a Docker engine or a snap core that executes on a server apparatus. In principle, other (orchestrated) container runtime environments, such as podman or Kubernetes, can also be used.

In accordance with the invention, the flow control components are each classified, based on the configuration information or the referenced memory map, with respect to access to at least one socket of the flow control environment when their execution is started, in particular before their execution is started. A classification for each of the flow control components is used to create or reference a permissions profile for socket access. Each of the permissions profiles establishes admissible or inadmissible operations related to the socket. Sockets may be in particular file or network sockets or may each provide an application programming interface.

In accordance with the invention, an individual token, associated with a permissions profile, for the socket access is created for each flow control component and is transferred to the respective flow control component. The tokens or the permissions profiles each have an application-specific resource access guideline combined with them that is transmitted to a control component for application, where the control component opens the respective socket. The socket access in each case is preferably effected based on the respective token and in accordance with the respective resource access guideline. By way of example, a first-hit or best-match method can be used to create or combine an application-specific resource access guideline to avoid conflicts between classification guidelines or resource access guidelines. In principle, it would also be possible to form a union of granted permissions that result from the classification guidelines or resource access guidelines. By way of example, a ban on an operation that is delivered according to a first guideline could be revoked by an authorization for the operation that is delivered according to a second guideline.

All in all, the present invention allows access to application programming interfaces (APIs) exposed via sockets to be protected selectively and dynamically by an assignment of instance-specific tokens. This allows individual operations on an instruction set provided via a socket to be specifically prohibited or permitted. In addition, an application of the present invention is not limited to local hosts, but rather is also possible in distributed systems, in particular in orchestrated distributed systems. An application of the present invention is therefore suitable in particular for environments in which scalability is important.

The flow control components are preferably classified based on a classification guideline. Generation or update of tokens in each case results in the respective token, the classification guideline and permissions profiles or permissions for the socket access that are referenced in the classification guideline being used to generate or adjust rules, which are stored in the respective resource access guideline. Generally, the classification guideline can establish sockets to be protected, permissions to be granted for sockets, memory locations of the resource access guidelines, properties of the respective flow control component that are envisioned in accordance with the configuration information or transfer methods for the tokens. This facilitates an exact and efficient classification of the flow control components.

The sockets are preferably each opened by the flow control environment. Here, the application-specific resource access guidelines are each transmitted to the flow control environment for application. In addition, the resource access guidelines are advantageously each implemented by the flow control environment, by an application that provides the respective socket, or by a functional component associated with the flow control environment or with the application. This ensures a reliable and effective implementation of the application-specific resource access guidelines.

The application-specific resource access guidelines advantageously each extend a standard guideline for opening the respective socket. The resource access guidelines can therefore be derived from a secure basis. The resource access guidelines are in particular application-specific security policies. A security policy is normally a technical or organizational document that is meant to implement and attain security requirements that exist in companies or institutions. Core elements are in particular ensuring integrity, confidentiality, availability or authenticity of information that is to be protected. A security policy for a datagram filter component or for a firewall establishes, for example, how a specific configuration is performed, what access rights are granted, how logging is implemented or what defensive measures the datagram filter component or firewall takes in an attack scenario. A security policy may exist in particular as a configuration file, as an XML file, as a device configuration, which can be evaluated directly automatically. It is likewise possible for a security policy to exist in text form, which is evaluated via methods based on artificial intelligence or machine learning. It is also possible for a security policy to exist in graphical form, which is evaluated via image processing or pattern recognition methods.

In accordance with a preferred embodiment of the present invention, an orchestration system detects setup, deletion or modification of the flow control components and registers the control applications with their respective execution status. In particular, the setup, deletion or modification of the flow control components each comprises allocating or enabling resources of the host. Advantageously, the tokens are generated or updated by an assignment component that is associated with the orchestration system. This facilitates particularly efficient and reliable management of the tokens. In order to meet high security requirements, classification guidelines, permissions profiles, tokens or resource access guidelines are managed preferably in a cryptographically protected manner by the orchestration system or the assignment component.

The system in accordance with the invention which is intended to perform the method in accordance with the disclosed embodiments and comprises a flow control environment formed via a host and also at least one flow control component for providing a control application. The flow control component can be loaded into and executed in the flow control environment. Configuration information comprising at least one reference to a memory map for the respective flow control component and application-specific stipulations for the use of resources of the host is prescribed for each of the flow control components.

In addition, the system in accordance with the invention is configured so that the flow control components are each classified, based on the configuration information or the referenced memory map, with respect to access to at least one socket of the flow control environment when their execution is started, in particular before their execution is started. The system is also configured so that a classification for each of the flow control components is used to create or reference a permissions profile for socket access. Each of the permissions profiles establishes admissible or inadmissible operations related to the socket.

The system in accordance with the invention is further configured so that an individual token, associated with a permissions profile, for the socket access is created for each flow control component and is transferred to the respective flow control component. Additionally, the system is further configured so that the tokens or the permissions profiles each have an application-specific resource access guideline combined therewith that is transmitted to a control component for application, where the control component opens the respective socket.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in more detail below using an exemplary embodiment with reference to the drawings, in which:

FIG. 1 shows a system for providing control applications that request access to a socket of a flow control environment in accordance with the invention; and

FIG. 2 shows a representation of a method sequence for providing control applications via the system shown in FIG. 1.

### DETAILED DESCRIPTION OF THE EXEMPLARY EMBODIMENTS

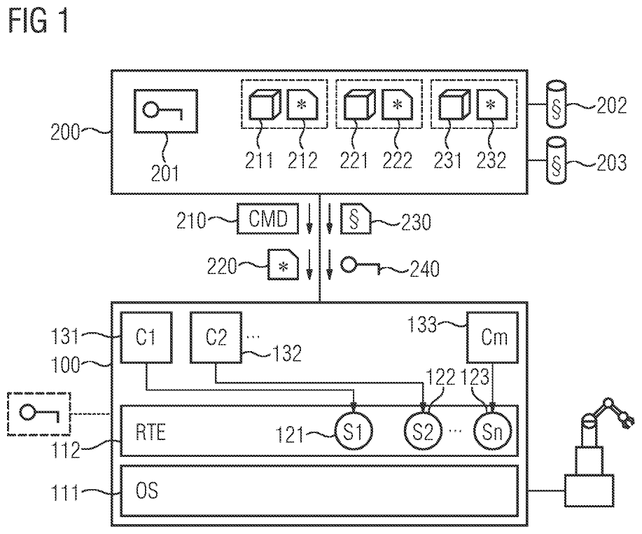

The system shown in FIG. 1 comprises a host 100 including a processor and memory for providing control applications of an industrial automation system via flow control components 131, which are implemented by software containers in the present exemplary embodiment. The control applications of the industrial automation system are exemplary time-critical services and can also include monitoring functions.

The host 100 can use the control applications to implement, for example, functions of control devices for an industrial automation system, such as programmable logic controllers (PLCs), or of field devices, such as sensors or actuators. In this way, the host 100 can be particularly used for exchanging control and measurement variables with machines or apparatuses controlled by the host 100. The host 100 can use acquired measurement variables to ascertain suitable control variables for the machines or apparatuses.

Alternatively or additionally, the host 100 can use the control applications to implement functions of an operating and observation station and can therefore be used to visually represent process data or measurement and control variables that are processed or acquired by automation devices. In particular, the host 100 can be used to display values relating to a control loop and to change control parameters or programs.

The system shown in FIG. 1 also comprises an orchestration system 200 that detects setup, deletion or modification of the flow control components and registers the control applications with their respective execution status. To this end, the orchestration system 200 provides at least one memory map (image) 211, 221, 231 for a software container and also associated configuration information 212, 222, 232, in particular to the host 100, for control applications in each case. In principle, the orchestration system 200 may be integrated into the host 100. There is preferably provision for an orchestration system 200 for multiple hosts, which use software containers to provide control applications.

The setup, deletion or modification of the flow control components each comprises allocating or enabling resources of the host 100. This is controlled by the orchestration system 200 by means of control instructions 210 and configuration information 220 transmitted to the host 100. The configuration information 220 is preferably deployment information, for example, docker-compose.yml configuration files. In particular, the configuration information 220 in each case comprises not only an indication of a memory map for the respective software container but also application-specific stipulations. The configuration information 220 is used for loading or executing each respective software container.

Signatures for the memory maps 211, 221, 231 and for the configuration information 212, 222, 232 are preferably used for checking the authenticity of the memory maps 211, 221, 231 and configuration information 212, 222, 232, for example, by an operator of the orchestration system 200 or automatically by the orchestration system 200. In addition, it is possible to check that only defined parameters within the memory maps 211, 221, 231 or configuration information 212, 222, 232 are set based on the respective signature. Accordingly, non-compliant memory maps 211, 221, 231 and configuration information 212, 222, 232 are not approved for use.

An operating system 111 of the host 100 has a flow control environment 112 installed thereon as an operating system application. The software containers or flow control components 131, 132, 133 can be loaded into and executed in this flow control environment 112. In principle, flow control components 131, 132, 133 can each be migrated from the host 100 to another host for execution thereon, or can be executed on other hosts at the same time.

In the present exemplary embodiment, the software containers each run on the operating system 111 of the host 100 within the flow control environment 112 in isolation from other software containers, container groups or pods. The software containers in this case each utilize one and the same kernel of the operating system 111 together with other software containers running on the host 100. The flow control environment 112 is preferably a container runtime environment or container engine.

Isolation of the software containers or isolation of selected operating system means from one another can be achieved in particular via control groups and namespaces. Control groups can be used to define process groups to limit available resources for selected groups. Namespaces can be used to isolate or conceal individual processes or control groups from other processes or control groups by virtualizing resources of the kernel of the operating system.

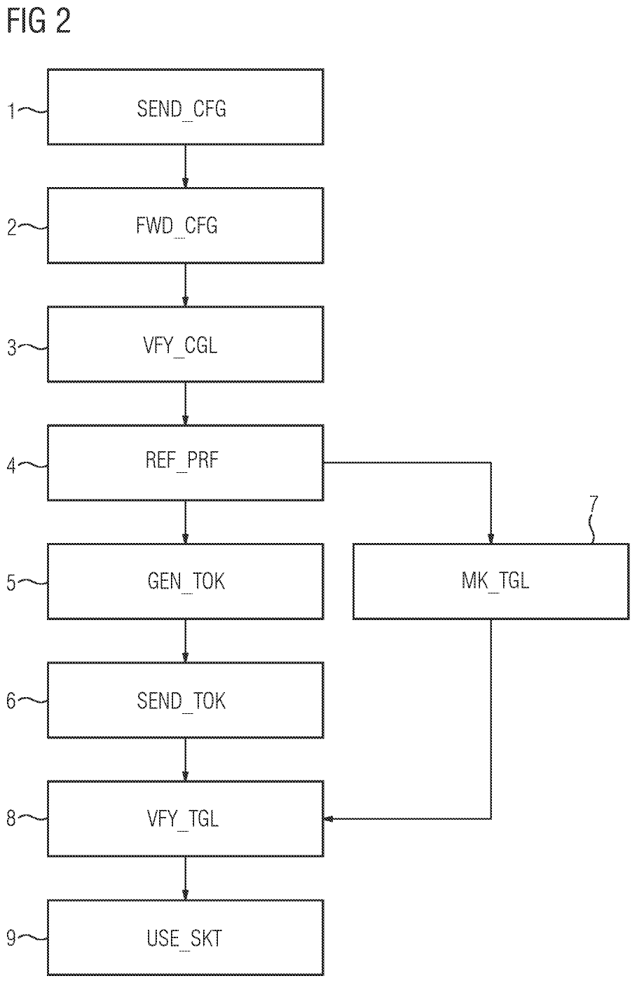

In order to provide control applications that request access to a socket of a flow control environment, configuration information 212, 222, 232 for the respective flow control component 131, 132, 133 is first transferred to the orchestration system 200 for these control applications in accordance with step 1 of the method sequence shown in FIG. 2. This configuration information 212, 222, 232 comprises at least one reference to a memory map 211, 221, 231 for the respective flow control component 131, 132, 133 and application-specific stipulations for the use of resources of the host 100 and is forwarded to an assignment component 201 in accordance with step 2.

In the present exemplary embodiment, the assignment component 201 is associated with the orchestration system 200. In principle, the assignment component 201 could also be integrated in the host 100 and could retrieve from the orchestration system 200 configuration and classification information required for controlling the access to a socket 121, 122, 123, or any predefined permissions profiles. The assignment component 201 may be configured as a plugin, library or external program, for example, and may be called, in particular under the control of the orchestration system 200, when an instance of a flow control component 131-133 is started or stopped.

The flow control components 131, 132, 133 are each classified by the assignment component 201, based on the configuration information 212, 222, 232 or the referenced memory map 211, 221, 231, with respect to access to at least one socket 121-123 of the flow control environment 112 before their execution starts (step 3). The sockets 121, 122, 123 are in particular file or network sockets or each provide an application programming interface (API). The flow control components are classified based on classification guidelines stored in a cryptographically secure manner in a database 202 associated with the orchestration system 200.

Possible aspects for a classification may be, by way of example, signatures of deployment information or images, provision of defined directories or files of a host to an instance of a flow control component during a mounting process when the instance is started, labels, process privileges or namespaces, in particular namespaces shared with a host or with other containers, which are assigned in deployment information or images.

Classification criteria may fundamentally be combined with one another in any form. A classification for each of the flow control components 131, 132, 133 is used to reference or dynamically create a permissions profile for socket access in accordance with step 4. Each of the permissions profiles establishes admissible or inadmissible operations related to the socket 121, 122, 123, in particular calls via an application programming interface associated with the respective socket 121, 122, 123. In order to reference predefined permissions profiles, there is provision in the present exemplary embodiment for an appropriate database 203, associated with the orchestration system 200, which stores the predefined permissions profiles in a cryptographically secure manner. The permissions profiles are preferably maintained by an operator of the orchestration system 200 independently of the classification guidelines. In principle, the permissions profiles can also establish just single operations related to a socket 121, 122, 123 as admissible or inadmissible.

In addition, the assignment component 201 creates, possibly updates, an individual token 240, associated with a permissions profile, for the socket access for each flow control component 131, 132, 133 (step 5) and transfers it to the respective flow control component 131, 132, 133 (step 6). The tokens 240 or the permissions profiles also each have an application-specific resource access guideline 230 combined with them that, in accordance with step 7, is transmitted to a control component of the host 100 for application, where the control component opens the respective socket 121, 122, 123. In the present exemplary embodiment, the sockets 121, 122, 123 are each opened by the flow control environment 112. Accordingly, the application-specific resource access guidelines 230 are each transmitted to the flow control environment 112 installed on the host 100 for application.

Generation or update of tokens 240 in each case results in the respective token 240, the classification guideline and permissions profiles or permissions for the socket access that are referenced in the classification guideline being used to generate or adjust rules, which are stored in the respective application-specific resource access guideline 230. As soon as an instance of a flow control component 131, 132, 133 having an assigned token 240 is stopped, the orchestration component 200 informs the assignment component 201 about this stoppage. The assignment component 201 then initiates an update for the respective application-specific resource access guideline 230 and removes rules for tokens that are no longer needed from the application-specific resource access guideline 230. Such an update can also be initiated when tokens 240 are valid only for a limited period.

For socket access, step 8 of the method sequence shown in FIG. 2 involves checking whether the respective flow control component 131, 132, 133 has a token 240 and whether a respective application-specific resource access guideline 230 corresponds to this token. If this is so, then the socket access is effected in accordance with step 9 based on the respective token 240 and in accordance with the respective resource access guideline 230. The resource access guidelines are each implemented by the flow control environment 112 as a policy enforcement point (PEP) in this case. Alternatively, the resource access guidelines 230 can be implemented by an application that provides the respective socket 121, 122, 123, or by a functional component associated with the flow control environment 112 or with the application.

In the present exemplary embodiment, the classification guidelines and permissions profiles and also resource access guidelines 230 and tokens 240 are managed in a cryptographically secure manner by the orchestration system or the assignment component 201. The classification guideline can establish in particular sockets 121, 122, 123 to be protected, permissions to be granted for sockets 121, 122, 123, memory locations of the resource access guidelines 230, properties of the respective flow control component that are envisioned in accordance with the configuration information 212, 222, 232 and transfer methods for the tokens 240. Possible transfer methods for the tokens 240 can provide for use of a secret volume or of a provided environment variable, for example.

By way of example, a first-hit or best-match method can be used to create or combine an application-specific resource access guideline in order to avoid conflicts between classification guidelines or resource access guidelines. A rule in a classification guideline can be used to assign a token to a flow control component in this case if a maximum of conditions specified in the respective rule is met for this rule compared with other rules in the classification guideline.

The resource access guidelines advantageously each extend a standard guideline for opening the respective socket 121, 122, 123. By way of example, the standard guideline may state that selected instances of the flow control components 131, 132, 133 fundamentally have access to a token 240 and that non-containerized applications fundamentally have no access to a token 240 or are permitted to access a socket 121, 122, 123 only using a standard token. If no tokens 240 have been assigned yet, then the resource access guidelines 230 each exclusively comprise the standard guideline.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for providing control applications for industrial automation devices, the control applications each being provided via flow control components which are loadable into and executable in a flow control environment formed via a host, and configuration information comprising at least one reference to a memory map for the respective flow control component and application-specific stipulations for the use of resources of the host being prescribed for each of the flow control components, the method comprising:
classifying each of the flow control components, based on at least one of the prescribed configuration information and the referenced memory map, with respect to access to at least one socket of the flow control environment when their execution is started;
utilizing a classification for each of the flow control components to create or reference a permissions profile for socket access, each of the permissions profiles establishing at least one of admissible and inadmissible operations related to the socket; and
creating an individual token, associated with a permissions profile, for the socket access for each flow control component and is transferring the created individual token to a respective flow control component;
wherein at least one of the tokens and the permissions profiles each have an application-specific resource access guideline combined therewith which is transmitted to a control component for application, said control component opening a respective socket.

2. The method as claimed in claim 1, wherein each socket access is effected based on the respective token and in accordance with the respective application-specific resource access guideline.

3. The method as claimed in claim 1, wherein the application-specific resource access guidelines each extend a standard guideline for opening the respective socket.

4. The method as claimed in claim 2, wherein the application-specific resource access guidelines each extend a standard guideline for opening the respective socket.

5. The method as claimed claim 1, wherein the flow control components are classified based on a classification guideline; and wherein each generation or update of tokens results in at least one of (i) the respective token, (ii) the classification guideline and permissions profiles and (iii) permissions for the socket access which are referenced in the classification guideline being utilized to generate or adjust rules, which are stored in the respective resource access guideline.

6. The method as claimed claim 2, wherein the flow control components are classified based on a classification guideline; and wherein each generation or update of tokens results in at least one of (i) the respective token, (ii) the classification guideline and permissions profiles and (iii) permissions for the socket access which are referenced in the classification guideline being utilized to generate or adjust rules, which are stored in the respective resource access guideline.

7. The method as claimed claim 3, wherein the flow control components are classified based on a classification guideline; and wherein each generation or update of tokens results in at least one of (i) the respective token, (ii) the classification guideline and permissions profiles and (iii) permissions for the socket access which are referenced in the classification guideline being utilized to generate or adjust rules, which are stored in the respective resource access guideline.

8. The method as claimed in claim 5, wherein the classification guideline establishes sockets to be protected, permissions to be granted for sockets, memory locations of the resource access guidelines, properties of the respective flow control component which are envisioned in accordance with at least one of (i) the configuration information and (ii) transfer methods for the tokens.

9. The method as claimed in claim 1, wherein the sockets are each opened by the flow control environment; and wherein the application-specific resource access guidelines are each transmitted to the flow control environment for application.

10. The method as claimed in claim 9, wherein the resource access guidelines are each implemented by one of (i) the flow control environment, (ii) an application which provides the respective socket and (iii) a functional component associated with the flow control environment or with the application.

11. The method as claimed in claim 1, wherein the configuration information in each case is utilized to at least one of load and execute the respective flow control component.

12. The method as claimed in claim 1, wherein the flow control components are software containers in which the flow control environment is a container runtime environment; and wherein the sockets are file or network sockets and/or each provide an application programming interface.

13. The method as claimed in claim 12, wherein an orchestration system detects at least one of (i) setup, (ii) deletion and (iii) modification of the flow control components;
wherein the orchestration system registers the control applications with their respective execution status; wherein at least one of the (i) setup, (ii) deletion and (iii) modification of the flow control components each comprise allocating or enabling resources of the host; and
wherein the tokens are generated or updated by an assignment component which is associated with the orchestration system.

14. The method as claimed in claim 13, wherein at least one of (i) classification guidelines, (ii) permissions profiles, (iii) tokens and (iv) resource access guidelines are managed in a cryptographically protected manner by at least one of the orchestration system and the assignment component.

15. The method as claimed in claim 1, wherein a first-hit or best-match method is utilized to create or combine an application-specific resource access guideline to avoid conflicts between at least one of classification guidelines and resource access guidelines.

16. A system for providing control applications for industrial automation devices, comprising:
a flow control environment formed via a host;
at least one flow control component for providing a control application, the at least one flow control component being loadable into and executable in the flow control environment, configuration information comprising at least one reference to a memory map for a respective flow control component and application-specific stipulations for the utilization of resources of the host being prescribed for each of the flow control components;
wherein the system is configured such that the flow control components are each classified, based on at least one of the configuration information and the referenced memory map, with respect to access to at least one socket of the flow control environment when their execution is started;
wherein the system is further configured such that a classification for each of the flow control components is utilized to create or reference a permissions profile for socket access, each of the permissions profiles establishing at least one of admissible and inadmissible operations related to the socket;
wherein the system is further configured such that an individual token, associated with a permissions profile, for the socket access is created for each flow control component and transferred to the respective flow control component; and
wherein the system is further configured such that at least one of the tokens and permissions profiles each have an application-specific resource access guideline combined with therewith which is transmitted to a control component for application, said control component opening the respective socket.
